(19) United States
(12) Patent Application Publication
(10) Pub. No.: US 2016/0004339 A1
(43) Pub. Date: Jan. 7, 2016

(54) PROGRAMMABLE DISPLAY DEVICE AND SCREEN-OPERATION PROCESSING PROGRAM THEREFOR

(71) Applicant: MITSUBISHI ELECTRIC CORPORATION, Chiyoda-ku, Tokyo (JP)

(72) Inventors: Kengo KOARA, Tokyo (JP); Hidenori KAWAI, Tokyo (JP)

(73) Assignee: MITSUBISHI ELECTRIC CORPORATION, Tokyo (JP)

(21) Appl. No.: 14/769,855

(22) PCT Filed: May 27, 2013
(86) PCT No.: PCT/JP2013/064636

§ 371 Date: Aug. 24, 2015

(51) Int. Cl. G06F 3/0354; G06F 3/0486; G05B 19/05; G06F 3/0485

(52) U.S. Cl. CPC G06F 3/03547; G06F 3/03545; G06F 3/03548; G06F 3/0485; G06F 3/0486; G05B 19/05; G05B 2219/13031; G05B 2219/13144

(57) ABSTRACT

A programmable display device includes a display unit, a coordinate input unit, a display processing unit, an operation processing unit, a control unit, and a switching unit switching between validation and invalidation of operation by screen gesture. The display screen includes a screen-gesture applicable area in which display content can be changed and a screen-gesture non-applicable area in which display content cannot be changed. When an operation by the screen gesture is invalid, the switching unit validates an operation on the operation object in the screen-gesture applicable area and the screen-gesture non-applicable area, and, when an operation by the screen gesture is valid, the switching unit invalidates an operation on the operation object in the screen-gesture applicable area and validates the screen gesture. When an operation by the screen gesture is valid, the display processing unit performs predetermined display in the screen-gesture applicable area.

### FIELD

The present invention relates to a programmable display device and a screen-operation processing program therefor.

### BACKGROUND

Computer devices including a display device and a coordinate input unit capable of detecting one or more touch-operation coordinates, such as tablet computers, smartphones, and programmable display devices used as display/operation terminals in industry, have come into wide use. With the advanced features and high screen resolution of such computer devices, the definition of display content has become higher. Meanwhile, when many pieces of information are displayed (arranged) on a screen having a limited size, the size of each element (object) becomes small, and this reduces visibility and operability. Particularly in touch operations, it is difficult to precisely indicate the coordinates of an object that has an insufficient size with respect to human fingers, and this tends to cause incorrect operations. The term “object” here refers to a virtual component on a computer, such as a component having a switch function that is operated by touch and a component having an information presenting function such as a graph or a lamp.

In response to such a problem, there are some computer devices that include a pen-shaped attachment (a stylus) for pointing at small objects. The stylus is effective for operations on small objects and operations requiring precision such as handwritten character input. However, the stylus has other problems such as it can be lost or damaged, and it is unsuitable for simultaneous operations at two or more points because, in the operation of a portable computer device, one hand holds the computer device and the other hand holds the stylus pen to operate the device.

As disclosed in Non Patent Literature 1, for example, there has been a product that provides a system for enlarging or reducing part of a display screen in response to the operation of touching two points simultaneously with two fingers and spreading the two points apart (referred to as “pinch open” or “pinch-out”) and the operation of narrowing the distance between the two points (referred to as “pinch close” or “pinch-in”), respectively. With this system, in a dynamic manner, it is possible to switch operations between an enlarged display of a target to be browsed or operated that is performed as needed to improve the visibility and operability and a reduced display of the target that is performed to overview and check many pieces of information. Further, display content can be scrolled (change of display positions) by moving a touch position while keeping touch on one point and then releasing the touch (referred to as “dragging”, or as “flicking” when hitting the point quickly). These operations including such movement of touch positions and change in the touch state are referred to as “gesture” (a gesture operation).

While there is such an operation of moving a touch position while maintaining the touch as described above, there are various types of gestures such as a tapping operation that is an operation of touching and releasing a point quickly, and a double-tapping operation that is an operation of consecutively tapping a point twice. In order to consecutively perform a determination of these gesture types, the determination is required to be performed on the basis of the number of touch points, the time period during which the touch is kept, and change in the touch coordinates. For example, assuming there is an object representing a virtual switch arranged on a screen with the characteristics described above, it is possible to visually present a touch operation acting on the switch in such a manner that the image of the switch is switched to an image in the pressed state at the moment when the switch is touched. However, it is not preferable to activate a function assigned to the switch (for example, the function of switching a screen) simultaneously with the touch. This is because, at the moment of the touch, the switch functions while it has not been distinguished whether the touch is an operation of the switch or a dragging or flicking operation, or whether the first touch of an operation for pinch open or pinch close is being performed accidentally in the area of the switch. This may cause an operation unintended by a user. In view of this, in a general computer device supporting gesture operations, when the touch state of an object requiring an operation such as a switch is released (when the touch is released), the type of operation is determined. For convenience, such a state where an object operates at the time of the release of the touch is referred to as “OFF synchronization” in the present specification. Meanwhile, the state where an object operates at the time of the touch of the object is referred to as “ON synchronization”.

Patent Literature 1 discloses a technique related to a touch-panel processing device that switches between a scroll mode for scrolling a screen and a flick mode for performing an assigned process according to a touch operation. With this technique, a long press on an arbitrary position is performed to switch to the flick mode, and after a menu (an operation guide including multiple sections) is displayed, a touch position is shifted for menu selection, and switching to the scroll mode is performed.

Furthermore, Patent Literature 2 discloses a technique of performing predetermined processing operations by setting a main input mode and an auxiliary input mode, and in the main input mode, a predetermined processing operation according to the detection result of a position detecting unit for each touch operation of a touch switch is performed, and in the auxiliary input mode, a predetermined processing operation is performed by using a plurality of touch operations of the touch switch as a series of related-operation input.

Further, Patent Literature 3 discloses a technique related to multiple touch operations, which are touch operations performed by an operator on device display areas on a monitor screen, of pinching a displayed target symbol of a plant device with two or more fingers, and spreading or narrowing touched parts or twisting and rotating these parts.

### CITATION LIST

### Patent Literatures

Patent Literature 1: International Publication No. WO2012/060352
Patent Literature 2: Japanese Patent Application Laid-open No. 2010-204964
Patent Literature 3: Japanese Patent Application Laid-open No. 2012-174127

### Non Patent Literature

Non Patent Literature 1: “iOS human interface guideline”, [online], Dec. 17, 2012, Apple Japan GK, Feb. 5, 2013, Internet (URL: https://developer.apple.com/jp/devcenter/ios/library/documentation/MobileHIG.pdf)

### SUMMARY

### Technical Problem

For example, in a programmable display device for industrial use, objects including switches are arranged and displayed in a display screen of the programmable display device. By operating these objects, operations are performed or an instruction is made for writing a value into a device of a control device such as a PLC (Programmable Logic Controller) that is connected to the programmable display device. If a case is considered where such a programmable display device is used for a manufacturing apparatus, it is necessary for a switch and the like to be operated at the moment of touch, that is, an object to function in ON synchronization in order to improve responsiveness as much as possible because the response speed of the switch affects productivity. Further, such a programmable display device also requires a switch for switching a value written into a device of a control device, depending on whether the switch is being pressed or not. Such a switch is referred to as “momentary switch”, and can be regarded as one of ON-synchronization objects, in an aspect that the switch operates at the moment of touch.

In such a programmable display device, similarly to general computer devices, in some cases, it is necessary to arrange many objects on a screen for simultaneously viewing the conditions of a device. Meanwhile, in such a programmable display device, a system that can correctly operate an object for operating a switch or the like by a touch operation is required more than in general computer devices. In order to satisfy the above requirements simultaneously, it is required that the programmable display device has a function of zooming in a part to be operated (information that is desired to be viewed, in some cases) as needed and operating objects even in ON synchronization.

With the technique of gesture operations used in general tablet computers or smartphones disclosed in Non Patent Literature 1, an operation of a switch by ON synchronization and a gesture operation such as zoom and scroll cannot be performed at the same time, as described above. Therefore, in some applications that require an operation of a switch by ON synchronization, enlarged/reduced display by pinch open/pinch close or scroll by dragging/flicking is invalidated, or a gesture operation on the switch is invalidated by limiting the area in which a gesture operation is applicable. Accordingly, enlargement of a display including a switch that operates in ON synchronization cannot be performed. This is because, when enlargement of a screen is performed by a gesture in an area excluding the switch, if the display area is filled with the switch as a result of the enlargement, subsequent gesture operations cannot be performed.

In Patent Literature 3, it assumed that the target symbol (an object) is a target of the multiple touch operations of pinching the target with two or more fingers and spreading and narrowing or twisting and rotating the pointed parts, and the target symbol itself can handle multiple touch operations. However, Patent Literature 3 does not disclose any method of performing operations such as enlarging/reducing or scrolling displayed content by multiple touch operations.

Meanwhile, in Patent Literature 1, a flick mode and a scroll mode are set. It is assumed that a long press on the screen is made as an operation of switching a mode for effectively utilizing the flick mode. Although Patent Literature 1 describes that, when a short press is made, it is possible to change the mode to the flick mode; however, this method has a high possibility of causing an incorrect operation of a switch that operates in ON synchronization. Therefore, this technique cannot be applied directly to programmable display devices that require ON synchronization.

Further, in Patent Literature 2, a main input mode and an auxiliary input mode are set and switching between these modes is performed by pressing of a shift button. However, Patent Literature 2 does not disclose any method of enlarging/reducing or scrolling a screen. Therefore, in Patent Literature 2, there is an assumption that there will not be a case, for example, where as a result of enlargement and scroll of the screen, the shift button moves outside a display area and operations cannot be performed.

Furthermore, in application software or basic software for personal computers, there is a certain type of software in which a left-click of a mouse operates objects while a right-click causes special menus (context menus) to be displayed, and mode switching is performed via the context menus. However, in touch operations, it is not possible to determine whether it is a left-click or a right-click. Therefore, this technique cannot be applied to devices operated mainly by touch operations.

The present invention has been achieved in view of the above problems, and an object of the present invention is to provide a programmable display device that monitors and operates a control device and can be operated by a touch operation, in which the operation of the control device can be performed by an ON synchronization operation and an enlargement/reduction or scroll operation of a display screen can be performed by a screen gesture operation on an arbitrary position on the display screen, and to provide a screen-operation processing program therefor.

### Solution to Problem

In order to achieve the above object, a programmable display device according to an aspect of the present invention is a programmable display device that monitors and operates a control device connected to the programmable display device via a communication line, including: a display unit; a coordinate input unit that detects at least one operation coordinate of an input indicator that is in contact with the display unit; a display processing unit that displays, in a display screen displayed in the display unit, a plurality of objects including a display object displaying only information or an operation object that is operable; an operation processing unit that extracts change of the input indicator from the operation coordinate of the input indicator obtained by the coordinate input unit; a control unit that performs a predetermined operation according to change of the input indicator; and a switching unit that switches between validation and invalidation of an operation by a screen gesture, wherein the display screen includes a screen-gesture applicable area in which display content is capable of being changed and a screen-gesture non-applicable area in which display content is not capable of being changed, when an operation by the screen gesture is invalid, the switching unit validates an operation on the operation object in the screen-gesture applicable area and the screen-gesture non-applicable area, and, when an operation by the screen gesture is valid, the switching unit invalidates an operation on the operation object in the screen-gesture applicable area and validates the screen gesture, and when an operation by the screen gesture is valid, the display processing unit performs predetermined display in the screen-gesture applicable area.

### Advantageous Effects of Invention

According to the present invention, because validation and invalidation of operations by screen gestures can be switched, when operations by screen gestures are invalidated, an operation on an operation object is performed in ON synchronization, and when operations by screen gestures are validated, an operation on an operation object arranged in a screen-gesture applicable area is invalidated. As a result, when display content in the screen-gesture applicable area is changed, even if an operation including touch on the screen is performed, an effect is obtained where an operation object included in the display content is not operated by mistake.

### BRIEF DESCRIPTION OF DRAWINGS

FIG. 1 is a diagram illustrating an example of objects used in a programmable display device.

FIG. 2 is a diagram illustrating an example of a display screen of the programmable display device.

FIG. 3 is a diagram illustrating an example of a display area of the programmable display device according to an embodiment.

FIG. 4 is an explanatory diagram of two modes that are switched by the programmable display device according to the embodiment.

FIG. 5 is a block diagram schematically illustrating a configuration of the programmable display device according to the embodiment.

FIG. 6 is a flowchart illustrating an example of procedures of a mode switching process in the embodiment.

FIG. 7 is a diagram illustrating an example of mode switching and a gesture operation when a base screen and a window screen exist in a mixed manner.

FIG. 8 is a flowchart illustrating an example of process procedures when a gesture operation is performed in a screen gesture mode in the embodiment.

FIG. 9 is a diagram illustrating an example of a scroll process in the screen gesture mode.

FIG. 10 is a diagram illustrating an example of behaviors when a zoom operation is performed in the screen gesture mode.

FIG. 11 is a diagram illustrating an example of an enlargement/reduction process in the screen gesture mode.

FIG. 12 is a diagram illustrating a relation between coordinate positions before and after zoom and/or scroll is applied.

### DESCRIPTION OF EMBODIMENTS

Exemplary embodiments of a programmable display device and a screen-operation processing program therefor according to the present invention will be explained below in detail with reference to the accompanying drawings. The present invention is not limited to the embodiments.

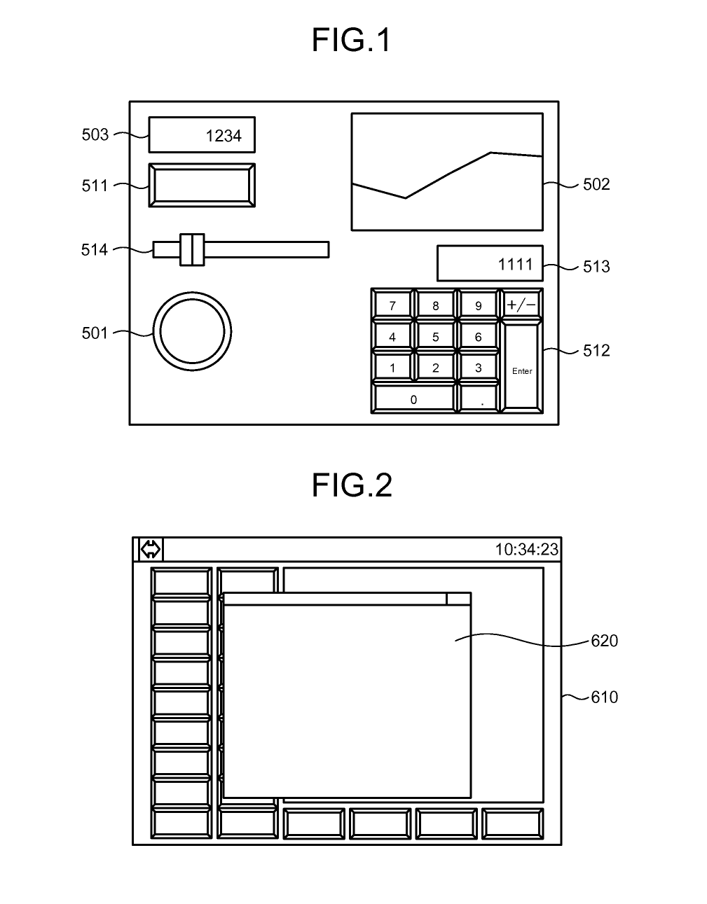

FIG. 1 is a diagram illustrating an example of objects used in the programmable display device. Objects used in a touch-panel programmable display device include display objects displaying only information and operation objects responding to operations, such as a touch switch.

The display objects include, for example, a lamp 501 switching display according to the device value of an external connection device, a trend graph 502 collecting device values on a regular basis and displaying a line graph of stored time-series information, and a numerical value display 503 displaying a device value in numerical form as it is.

The operation objects include, for example, a switch 511 rewriting a device value with a touch operation, numerical value input 513 normally displaying a device value in numerical form and setting a numerical value in the device by input from a ten key 512 for changing numerical values, and slider control 514 changing a value continuously by moving a touch position while touching a “knob” arranged in a predetermined area and setting a value at a point when the touch is released in the device. A window frame for adjusting the position or size of a window screen can be regarded as a kind of the operation objects.

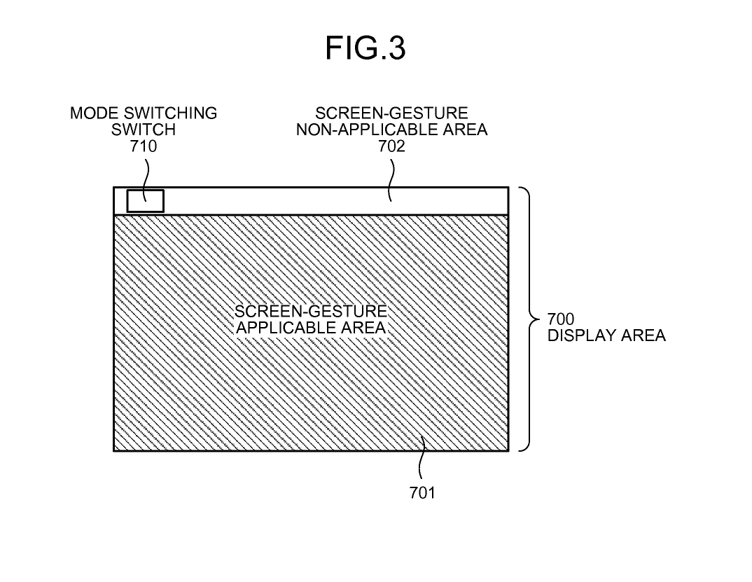

FIG. 2 is a diagram illustrating an example of a display screen of the programmable display device. The programmable display device can display a base screen 610, which is a screen displayed on the entire display unit, and a window screen 620, which is a screen displayed on part or the entirety of the display unit so as to cover the base screen 610. A plurality of the window screens 620 can be displayed on the display unit. At least any of a display object and an operation object is arranged as appropriate on the base screen 610 and the window screen 620. The arrangement of the display object and the operation object is defined by project data.

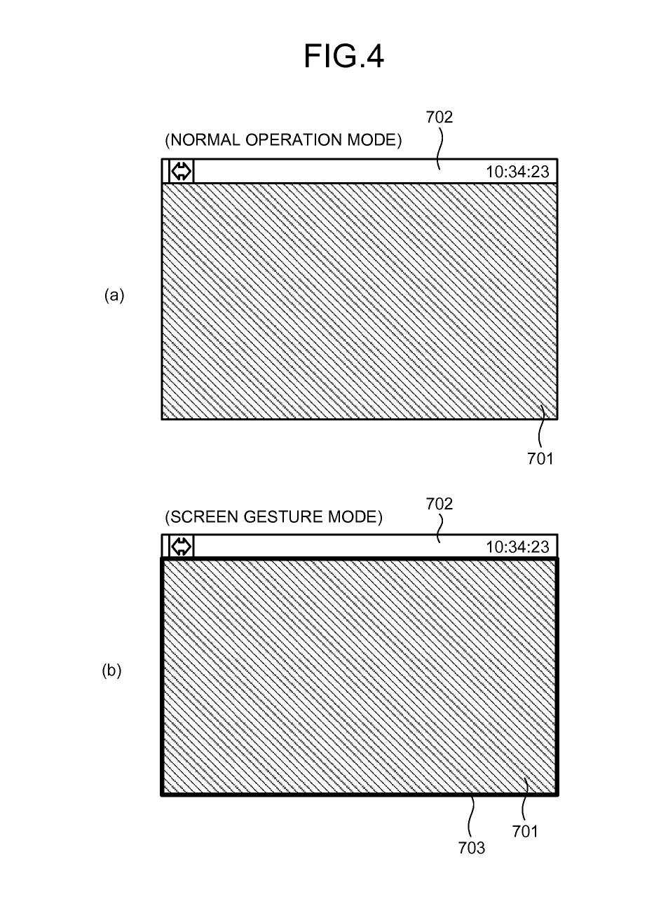

FIG. 3 is a diagram illustrating an example of a display area of the programmable display device according to the present embodiment. In the present embodiment, areas on a display screen are distinguished in such a way that part of a display area 700 of the programmable display device is set as a screen-gesture applicable area 701 where screen gestures by a user are valid while the remaining area is set as a screen-gesture non-applicable area 702 where screen gestures by the user are invalid. That is, when an instruction is issued by a screen gesture to change display content, the display content is changed according to the instruction in the screen-gesture applicable area 701, while the display content is not changed in the screen-gesture non-applicable area 702.

In this example, the screen-gesture non-applicable area 702 is provided in a belt shape in the uppermost part of the display area 700. In the screen-gesture non-applicable area 702, a mode switching switch 710 as an operation object for switching between a normal operation mode and a screen gesture mode, which are described later, is arranged. Each time the mode switching switch 710 is pressed, switching is made between the normal operation mode and the screen gesture.

The normal operation mode is a mode in which operations are performed on the basis of the setting in project data set in the programmable display device. The screen gesture mode is a mode for invalidating operations on operation objects arranged in the screen-gesture applicable area 701, while changing the display content in the screen-gesture applicable area 701 on the basis of a predetermined operation performed in the screen-gesture applicable area 701. In this case, changing the display content means enlargement or reduction of the display content or changing (scrolling) the display position, for example. That is, in the normal operation mode, operations on operation objects displayed on the display screen, for example, are validated and when an operation object is operated, the operation object operates in ON synchronization. In contrast, in the screen gesture mode, because operations on the operation objects are invalidated, any operation does not operate in ON synchronization, even when an input indicator, such as a finger, is in contact with the operation object.

In the screen gesture mode, while operations on the operation objects in the screen-gesture applicable area 701 are invalidated, operations on the operation objects arranged in the screen-gesture non-applicable area 702 can be performed. Accordingly, even in the screen gesture mode, switching to the normal operation mode can be performed by operating the mode switching switch 710 arranged in the screen-gesture non-applicable area 702. Each screen (for example, each of the base screen 610 and the window screen 620) can be set as the screen-gesture applicable area 701 or the screen-gesture non-applicable area 702 in the project data.

FIG. 3 illustrates the screen-gesture applicable area 701 having a rectangular shape as an example; however, the shape is not limited to a rectangular shape and can be an ellipse or arbitrary polygon. As described above, it is desirable that the screen-gesture applicable area 701 can be set to each screen. The reason therefor is that it is generally preferable to distinguish whether a screen gesture function is applied for each displayed screen. However, to simplify the setting, the screen-gesture applicable area 701 may be set to each project data.

FIG. 4 is an explanatory diagram of two modes that are switched by the programmable display device according to the present embodiment, where FIG. 4(a) is a diagram illustrating an example of a screen state in the normal operation mode and FIG. 4(b) is a diagram illustrating an example of a screen state in the screen gesture mode. In the normal operation mode, as illustrated in FIG. 4(a), it is possible to operate operation objects (not illustrated) arranged in the screen-gesture applicable area 701 and the screen-gesture non-applicable area 702. Meanwhile, in the screen gesture mode, as illustrated in FIG. 4(b), to allow a user to visually recognize that the display screen is in the screen gesture mode, the displaying manner is set to be different from that in the normal operation mode. In this example, in the screen gesture mode, the outer peripheral portion of the screen-gesture applicable area 701 is surrounded by a thick line 703. The thick line 703 may be colored in a visually distinctive color, such as red, or may be blinked.

The thick line 703 is used as a line for surrounding the screen-gesture applicable area 701 in order to prevent the display content in the screen-gesture applicable area 701 from being affected as much as possible, even in the screen gesture mode. That is, using the thick line 703 for the outer peripheral portion of the screen-gesture applicable area 701 does not significantly reduce the area of the screen-gesture applicable area 701. Therefore, it is not necessary to zoom out the content displayed in the screen-gesture applicable area 701. However, depending on the screen content to be displayed, for example, an icon indicating that the display screen is in the screen gesture mode can be displayed on the display screen in a superimposed manner, instead of using such a thick line surrounding the screen-gesture applicable area 701.

On the other hand, in the normal operation mode, in consideration of the effective utilization of the display area 700 by displaying as less extra information as possible, FIG. 4(a) illustrates a case where no special display for indicating that the display screen is in the normal operation mode is performed. However, special display for indicating that the display screen is in the normal operation mode can be performed.

In this way, in the present embodiment, the screen-gesture applicable area 701 and the screen-gesture non-applicable area 702 are provided in the display screen and the mode switching switch 710 for switching between the normal operation mode and the screen gesture mode is provided in the screen-gesture non-applicable area 702. In the normal operation mode, when an operation object is touched, the operation object operates in ON synchronization, whereas in the screen gesture mode, even when an operation object is touched, the operation object does not operate in ON synchronization, but operates after determining an operation instruction of a screen gesture on the basis of the trajectory of the screen gesture. A programmable display device achieving such functions is described below.

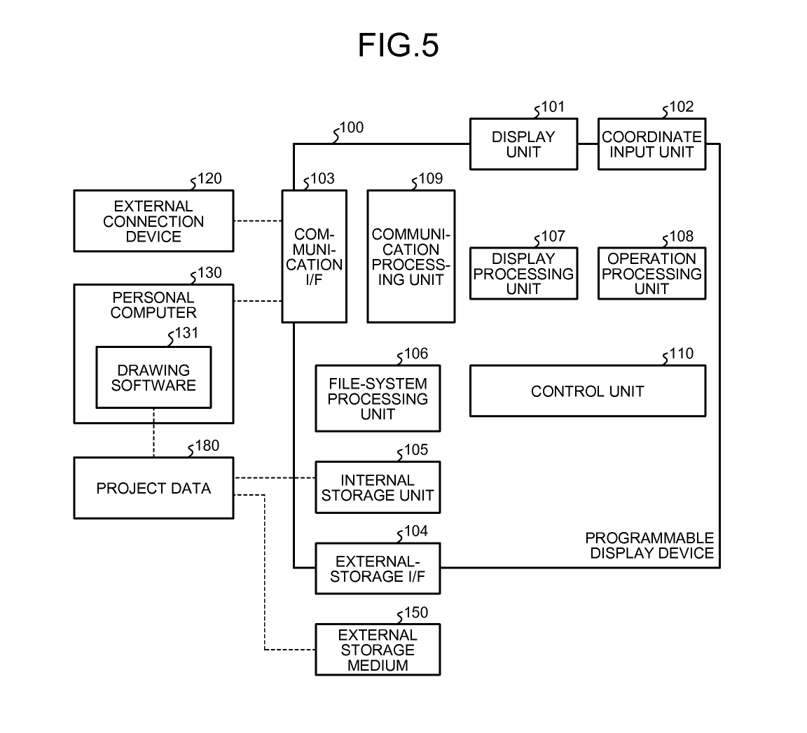

FIG. 5 is a block diagram schematically illustrating a configuration of the programmable display device according to the present embodiment. A programmable display device 100 includes a display unit 101, a coordinate input unit 102, a communication interface unit 103 (denoted as “communication I/F” in FIG. 5), an external-storage interface unit 104 (denoted as “external-storage I/F” in FIG. 5), an internal storage unit 105, a file-system processing unit 106, a display processing unit 107, an operation processing unit 108, a communication processing unit 109, and a control unit 110.

The display unit 101 is constituted by, for example, a liquid crystal display or an organic EL (Electroluminescence) display.

The coordinate input unit 102 is a touch panel that is arranged such that it overlaps with the display unit 101, for example, and detects coordinates (touch coordinates) of a contact position with an input indicator, such as a finger. The coordinate input unit 102 can detect a plurality of touch coordinates simultaneously. Examples of a touch panel that can detect a plurality of touch coordinates simultaneously include a variety of products such as that of a resistance film type, an electrostatic capacity type, and an optical type, and any of these types can be used.

The communication interface unit 103 is a part serving as an interface when communication is performed with an external connection device 120 such as a control device, a personal computer 130, or the like.

The external-storage interface unit 104 is a part serving as an interface when communication is performed with a portable external storage medium 150 such as a memory card or a USB (Universal Serial Bus) memory.

The internal storage unit 105 is constituted by a nonvolatile storage medium, such as a NAND or NOR flash memory or a hard disk device.

In the internal storage unit 105 or the external storage medium 150, for example, project data 180 for operating the programmable display device 100 is stored. The project data 180, for example, includes screen data to be displayed on the display unit 101. The screen data includes arrangement positions of operation objects or display objects. In the internal storage unit 105 or the external storage medium 150, a mode-status storage area in which mode status information indicating the current mode of a mode switching switch is stored is provided. For example, the mode status information stores therein a mode status for each display screen.

The file-system processing unit 106 performs reading and writing of the project data 180, which is stored in the internal storage unit 105 or the external storage medium 150.

The display processing unit 107 causes the display unit 101 to display a predetermined screen on the basis of the project data 180. The display processing unit 107 combines display content on the display unit 101 while taking overlapping of the base screen 610 and the window screen 620 into consideration.

The operation processing unit 108 extracts change of an input indicator from the touch coordinates of the input indicator from the coordinate input unit 102. For example, in the normal operation mode, the operation processing unit 108 detects a pressing operation when the operation object is a button or detects a touch position and a release position of slider control. In the screen gesture mode, the operation processing unit 108 obtains, from the coordinate input unit 102, the number of touch points of an input indicator, touch coordinates, and the distance between two touch positions when the number of touch points is two, and then calculates change in the number of touch points, a reference point of touch coordinates, a displacement of the touch coordinates from the reference point, the reference distance as a distance between two reference touch positions, or distance change from the reference distance.

The communication processing unit 109 has a function to perform communication with the external connection device 120. The communication processing unit 109 has a communication protocol different for each external connection device 120 and accommodates the difference in the communication method due to the difference in the external connection device 120.

The control unit 110 reads the project data 180 via the file-system processing unit 106, and interprets the content of the project data 180 to perform a process with respect to objects to be displayed on the display unit 101 or to perform a process with respect to a non-object function without involving any object, such as a logging function of collecting data.

The control unit 110 reads a device value from the external connection device 120 that is connected via the communication interface unit 103 on the basis of the setting in the project data 180, and writes the device value into the external connection device. Further, on the basis of the device value of the external connection device 120 obtained via the communication processing unit 109, the control unit 110 responds to device value.

The control unit 110 identifies an operation by an input indicator on the basis of the output result from the operation processing unit 108, and performs a process corresponding to the operation. For example, when an operation object indicating writing of a device value into the external connection device 120 is pressed in the normal operation mode, the control unit 110 instructs the display processing unit 107 to change the display of the operation object to the pressed state and instructs the communication processing unit 109 to write the device value into the corresponding external connection device 120. Meanwhile, when an input indicator issues an instruction to change display content in the screen gesture mode, the control unit 110 calculates the change instruction on the basis of the output result from the operation processing unit 108, and issues the change instruction to the display processing unit 107.

The project data 180 is created or edited by drawing software 131, which is one of applications in the personal computer 130. The project data 180 can be copied to the external storage medium 150 by the personal computer 130, and the project data 180 can be transferred via the communication interface unit 103 to the internal storage unit 105 of the programmable display device 100 or to the external storage medium 150 incorporated in the external-storage interface unit 104.

The programmable display device 100 having such a configuration is used as a display and input device that is a replacement product for a display device, such as an electrical or mechanical lamp or meter, or an operation inputting device, such as a switch and a volume control, for example, in a manufacturing apparatus.

In order to cause a control target device to perform a desired operation in real time, a control device such as a PLC generally performs a series of processes including receiving predetermined data from the control target device, performing predetermined calculations on the basis of the received data, and transmitting the calculation result to the control target device, at a predetermined cycle. In the present embodiment, an instruction or an operation command from the programmable display device 100 to the control device in the normal operation mode is transmitted in real time, that is, in ON synchronization.

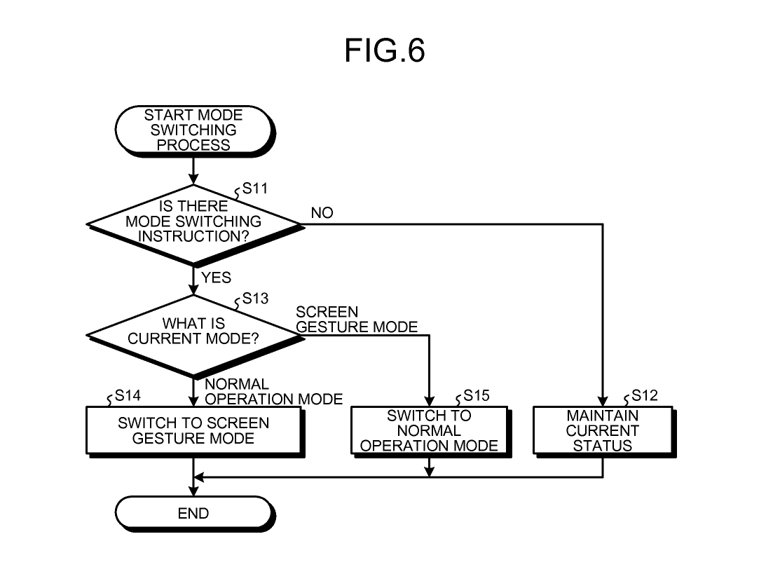

Next, processing in the programmable display device having such a configuration is described. FIG. 6 is a flowchart illustrating an example of procedures of the mode switching process in the present embodiment.

First, the coordinate input unit 102 detects touch coordinates of an input indicator of a user at a predetermined time interval, and outputs the detection result to the operation processing unit 108. The operation processing unit 108 obtains the input state of the user from the touch coordinates of the input indicator and the change in the touch coordinates over time. The control unit 110 determines whether a mode switching instruction has been issued on the basis of the input state (Step S11). For example, as described above, in a case where the mode switching instruction is issued by pressing the mode switching switch 710 arranged in the screen-gesture non-applicable area 702, when a tapping operation on the mode switching switch 710 in the screen-gesture non-applicable area 702 is performed, it is determined that a mode switching instruction has been issued, and when no tapping operation on the mode switching switch 710 is performed, it is determined that no mode switching instruction has been issued.

When there is no mode switching instruction (NO at Step S11), the current status is maintained (Step S12), and the process ends. When there is a mode switching instruction (YES at Step S11), the control unit 110 obtains the current mode from the mode-status-information storage area provided in the internal storage unit 105 or in the external storage medium 150 (Step S13). When the current mode is in the normal operation mode (a case of the normal operation mode at Step S13), the control unit 110 switches the mode to the screen gesture mode (Step S14), and the process ends. For example, the mode is switched from the normal operation mode illustrated in FIG. 4(a) to the screen gesture mode illustrated in FIG. 4(b).

Meanwhile, when the current mode is in the screen gesture mode (a case of the screen gesture mode at Step S13), the control unit 110 switches the mode to the normal operation mode (Step S15), and the process ends. In this case, for example, the mode is switched from the screen gesture mode illustrated in FIG. 4(b) to the normal operation mode illustrated in FIG. 4(a), for example.

In the above example, a case where switching between the normal operation mode and the screen gesture mode is performed each time the mode switching switch 710 is pressed has been described. Similarly to the arrangement of other objects, the arrangement of the mode switching switch 710 is included in the project data 180 and is set by the drawing software 131.

As another method for switching the mode, it is also possible to define a long-press operation, which is an operation of continuously touching a position other than operation objects in the display area 700 for a predetermined time, as a screen gesture. Specifically, in the normal operation mode, switching to the screen gesture mode is performed by a long-press operation on an arbitrary position other than operation objects in the display area 700 for a predetermined time, while in the screen gesture mode, switching to the normal operation mode is performed by a long-press operation on an arbitrary area in the screen-gesture applicable area 701 or an area other than the operation objects in the screen-gesture non-applicable area 702.

As still another method, it is also possible to define a double-tapping operation, which is an operation of consecutively touching a position other than the operation objects in the display area 700 twice within a predetermined time, as a screen gesture for switching the mode. Specifically, in the normal operation mode, switching to the screen gesture mode is performed by a double-tapping operation on an arbitrary position other than the operation objects in the display area 700, while in the screen gesture mode, switching to the normal operation mode is performed by a double-tapping operation on an arbitrary area in the screen-gesture applicable area 701 or an area other than the operation objects in the screen-gesture non-applicable area 702.

Furthermore, in the screen gesture mode, when a no-operation state continues for a predetermined time, it is also possible to switch from the screen gesture mode to the normal operation mode automatically (hereinafter, “screen-gesture-mode automatic releasing function”). The term “no-operation state” refers to a state where no touch is performed after detection of release of the last touch operation. When the screen-gesture-mode automatic releasing function is used, it suffices that the time to automatic release is also set in the project data 180.

Methods of using a switch, long-press, and double-tapping have been described above as examples of means for switching the mode. However, any methods including a method using a simultaneous touch to a plurality of points or a slide operation of moving the touched position in a predetermined direction can be also used, as long as these methods can be distinguished from a simple touch (tap) operation. Note that, when there is an ON-operation switch, it is desirable to provide an explicit switch for switching the mode (the mode switching switch 710) from the viewpoint of preventing incorrect operations.

The method to be used as means for switching the mode can be freely selected by a creator (a screen designer) of the project data 180 of the programmable display device 100 with the drawing software 131, depending on a device or a system to which the programmable display device 100 is applied and can be set in the project data 180.

It is also possible that the display content in the screen-gesture non-applicable area 702 is displayed while being switched to other display content prepared in advance only in the screen gesture mode.

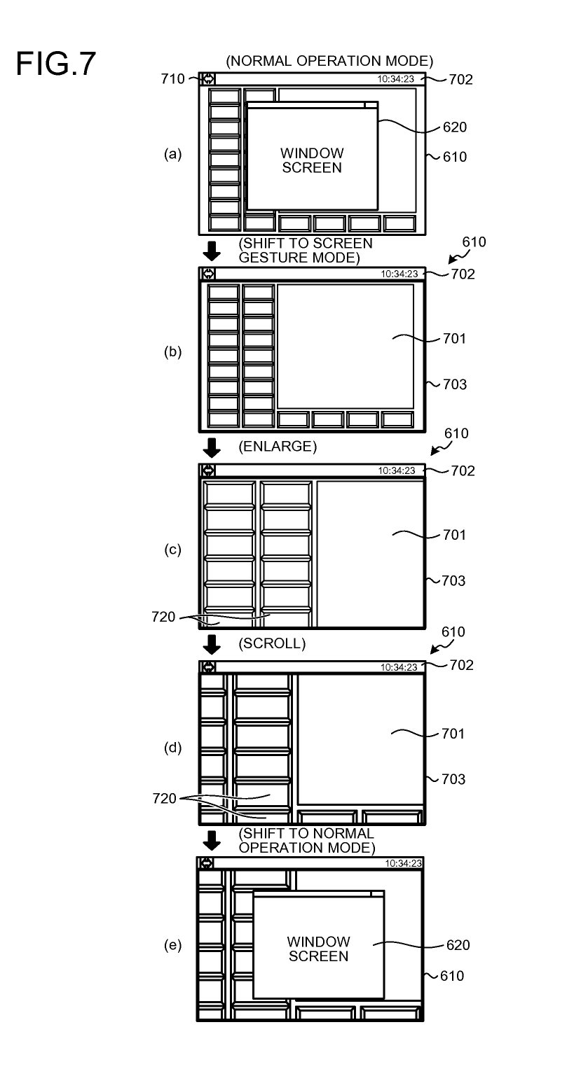

Next, processes performed when the base screen 610 and the window screen 620 exist in a mixed manner are described. FIG. 7 is a diagram illustrating an example of mode switching and a gesture operation when a base screen and a window screen exist in a mixed manner. As illustrated in FIG. 7(a), the window screen 620 is displayed on the base screen 610. In this case, it is assumed that a target to which the screen gesture function is applied is the base screen 610 and the display screen is in the normal operation mode.

When a user presses the mode switching switch 710 in the screen-gesture non-applicable area 702 in the base screen 610 in this state, the mode shifts to the screen gesture mode in FIG. 7(b). At this point, only the base screen 610 shifts to the screen gesture mode and the screen gesture mode is not applied to the window screen 620 to be superimposed on the base screen 610. That is, in the base screen 610, enlargement/reduction and scroll of the display content in the screen-gesture applicable area 701 are performed, but display of the window screen 620 is not influenced. Further, in the screen gesture mode, the window screen 620 to which the screen gesture mode is not applied is hidden.

Subsequently, for example, when a predetermined operation for enlarging display content such as pinch-out is performed at a predetermined position in the screen-gesture applicable area 701 in the screen gesture mode, the base screen 610 is zoomed in as illustrated in FIG. 7(c). When a predetermined operation for moving a display area such as a dragging operation is performed in this state, the display area moves as illustrated in FIG. 7(d). Even when these operations are performed on an operation object, the operation object does not operate because these operations are performed in the screen gesture mode. In the example in FIG. 7, even when an operation is performed on a button-shaped operation object 720, the button-shaped operation object 720 is not pressed.

Subsequently, when the mode switching switch 710 in the screen-gesture non-applicable area 702 in the base screen 610 is pressed, the mode shifts to the normal operation mode as illustrated in FIG. 7(e). At this point, the window screen 620 is displayed again in a superimposed manner on the base screen 610 that has been enlarged and scrolled.

When a plurality of window screens are displayed and a user wishes to cause one of the window screens to enter the screen gesture mode, mode switching is performed on the one window screen to shift it to the screen gesture mode. At this point, window screens other than the window screen to which the screen gesture function is applied are hidden. While display of the base screen may be continued, in order to inform a user that operations to the base screen are invalidated, for example, the base screen may be filled with a predetermined pattern so as to be hidden in appearance, or the saturation of the base screen may be lowered.

Reasons why the window screen 620 other than the screen to which the screen gesture function is applied is temporarily hidden in the screen gesture mode as described above are explained. One of the reasons is that, if the display of the window screen 620 other than the screen to which the screen gesture function is applied is maintained, when the window screen 620 is superimposed on the screen-gesture applicable area, it is difficult in some cases to perform an operation by a screen gesture. Another reason is that the possibility of an incorrect operation to the window screen 620 to which the screen gesture function is not to be applied becomes a problem. On the other hand, non-display of the base screens 610 or equivalent display thereto provides an effect that a target of the screen gesture function is clearly shown. When a screen to which the screen gesture function is applied is displayed, the base screen 610 is displayed, and operations are allowed to be performed, it is possible to use the base screen 610 for the same purpose as that of the screen-gesture non-applicable area 702 by arranging the mode switching switch 710 in the base screen 610.

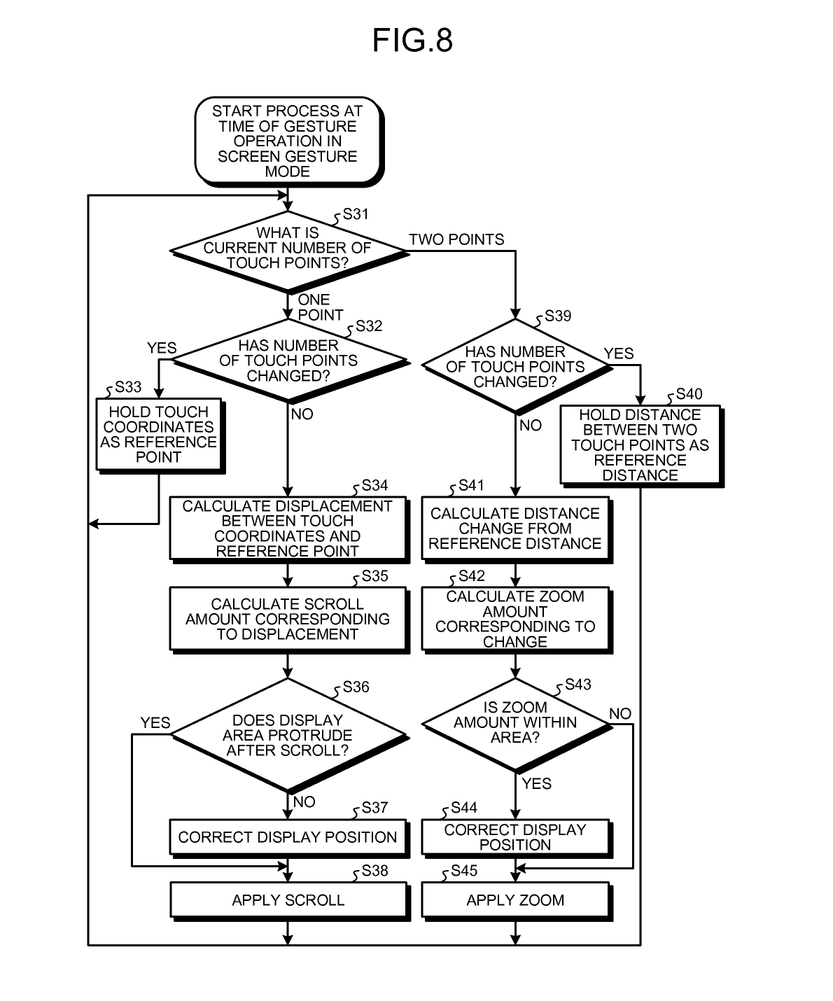

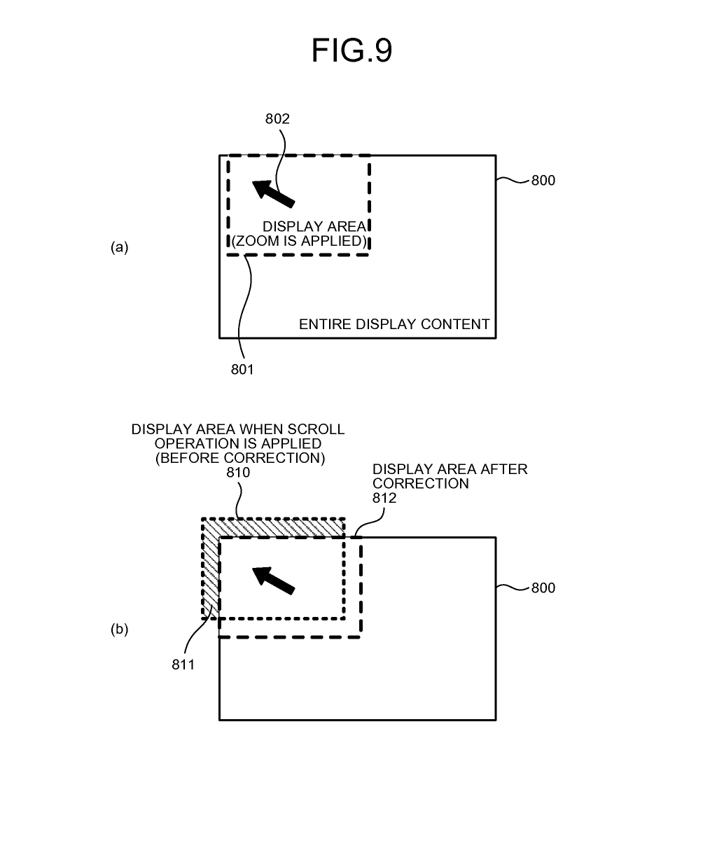

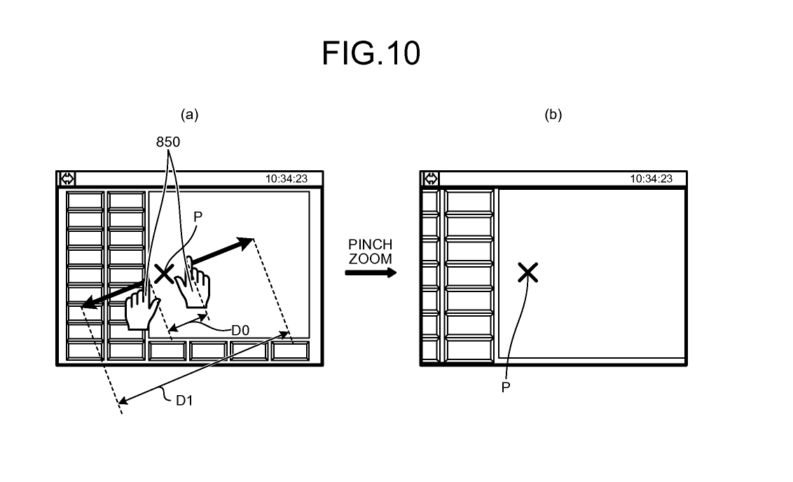

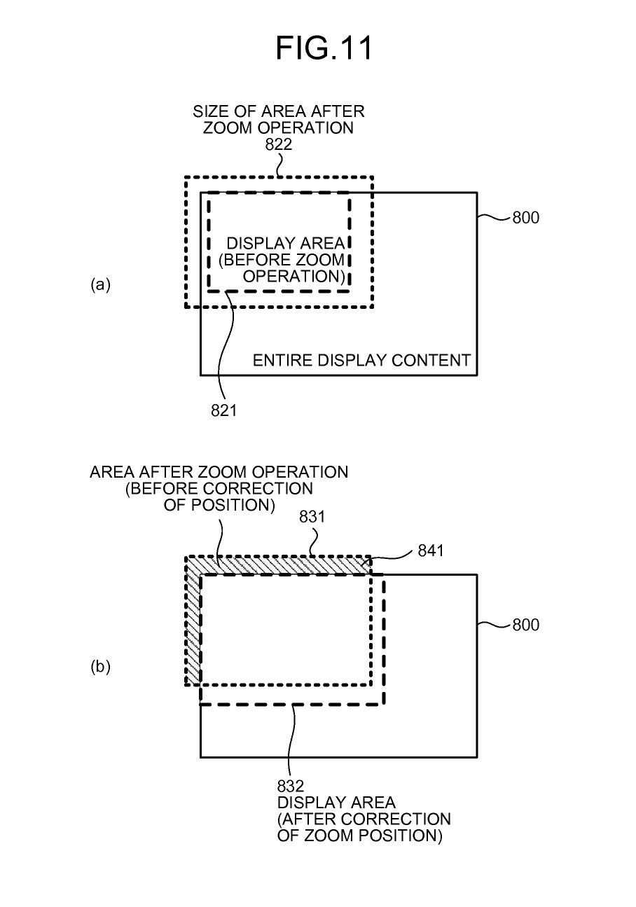

Next, process procedures for determination of a gesture operation in the screen gesture mode and behaviors when a gesture operation is performed are described. FIG. 8 is a flowchart illustrating an example of process procedures when a gesture operation is performed in a screen gesture mode in the present embodiment, FIG. 9 is a diagram illustrating an example of a scroll process in the screen gesture mode, FIG. 10 is a diagram illustrating an example of behaviors when a zoom operation is performed in the screen gesture mode, and FIG. 11 is a diagram illustrating an example of an enlargement/reduction process in the screen gesture mode. In this case, it is assumed that the display screen is in the screen gesture mode.

The control unit 110 periodically causes the operation processing unit 108 to check the number of touch points and touch coordinates that are detected by the touch panel (the coordinate input unit 102), and the control unit 110 processes the results of the check.

First, the operation processing unit 108 checks the current number of touch points (Step S31). When the number of touch points is one, whether the number of touch points has changed from the preceding state is determined (Step S32). When the number of touch points has changed (YES at Step S32), that is, when no point was touched or two or more points were touched in the preceding state and one point is touched this time, the operation processing unit 108 holds the current touch coordinates as a reference point of touch coordinates (Step S33). The process then returns to Step S31.

Meanwhile, when the number of touch points has not changed from the preceding state (NO at Step S32), the operation processing unit 108 calculates the displacement between the current touch coordinates and the reference point of touch coordinates (Step S34). Subsequently, the control unit 110 calculates a scroll amount corresponding to the displacement from the reference point of touch coordinates that is obtained from the operation processing unit 108 (Step S35). Change in the scroll amount here is made to match physical change in the touch coordinates on the display unit 101. FIG. 9(a) illustrates that the content to which zoom is applied and then displayed in the display unit 101 is a display area 801 of display content 800 in its entirety. It is assumed that scroll has been performed in a direction of an arrow 802 in the display area 801.

Next, the control unit 110 checks whether the display area includes an area outside the display content 800 (protrudes from the display content 800) as a result of the scroll (Step S36). When the display area includes an area outside the display content 800 (NO at Step S36), the display position is corrected so as not to cause any protrusion to occur (Step S37). When the display area 801 is scrolled along the arrow 802 as it is as illustrated in FIG. 9(b), the display content 800 and an area (a protruding area) 811 outside the display content 800 are included in a display area 810 after the scroll. Therefore, when the display position is corrected so as not to include the protruding area 811 in the display area 810, the corrected area becomes a corrected display area 812.

Thereafter, or when an area outside the display content 800 is not included in the display area at Step S36 (YES at Step S36, a case where the display area 801 is included in the display content 800 as in FIG. 9(a)), display on the display unit 101 is updated by applying the scroll in a state with no protrusion (Step S38). The process then returns to Step S31.

When the current number of touch points is two at Step S31, the operation processing unit 108 checks whether the number of touch points has changed from the preceding state (Step S39). When the number of touch points has changed from the preceding state (YES at Step S39), that is, when the number of touch points at the preceding state is one or less or three or more, the operation processing unit 108 holds the distance between the current two touch positions as a reference distance (Step S40). The process then returns to Step S31.

Meanwhile, when the number of touch points has not changed from the preceding state (NO at Step S39), the operation processing unit 108 calculates the amount of change between the reference distance obtained at Step S40 and the distance between the current two touch positions (Step S41). Subsequently, the control unit 110 calculates a zoom amount (an amount of enlargement or reduction of display content) on the basis of the amount of change in the distance between the two touch positions obtained from the operation processing unit 108 (Step S42). In this case, when the reference distance is D0, the distance between the current two points is D1, the zoom amount before the start of a zoom operation is Z0, a minimum zoom amount is Zmin, a maximum zoom amount is Zmax, and k is an appropriate coefficient, a new zoom amount Z is calculated by the following expression (1). Note that Zmin≦Z≦Zmax is established here.

Z=k·Z0·D1/D0 (1)

In this case, as illustrated in FIG. 10, the center of the zoom is a middle point P between the two points from which the reference distance D0 is calculated. The middle point P of the reference distance D0 when two input indicators 850 are in contact with the display unit 101 in FIG. 10(a) is the center of zoom. After the distance between the two input indicators 850 has become D1, as illustrated in FIG. 10(b), a zoom process is performed with the middle point P as the center.

FIG. 11(a) illustrates a case where reduction of zoom is applied to a display area 821. With this zoom operation, an area to be displayed on the display unit 101 after the zoom operation increases such that, for example, a display area 822 is displayed.

The control unit 110 checks whether an area outside the display content 800 is included in (protruded from) the display area 822 after the zoom operation (Step S43). When an area outside the display content 800 is included in the display area (YES at Step S43), the display position is corrected so as not to cause any protrusion to occur (Step S44). When the display area 821 is zoomed out (reduced) as illustrated in FIG. 11(b), a display area 831 after the zoom includes the display content 800 and an area (a protruding area) 841 outside the display content 800. Thus, when the display position is corrected so as not to include the protruding area 841 in the display area 831, the corrected area becomes a corrected display area 832.

Thereafter, or when an area outside the display content 800 is not included in the display area at Step S43 (NO at Step S43, a case of, for example, the display area 832 in FIG. 11(b) included only in the display content 800), the display on the display unit 101 is updated by applying the zoom in a state with no protrusion (Step S45). The process then returns to Step S31.

In the above descriptions, correction of protrusion is performed in such a way that the display area does not include an area outside the display content 800 when the scroll or zoom is performed. Alternatively, for example, it is also possible to fill the outside of the display content 800 with a predetermined pattern and display a predetermined pattern in a protruding area without performing any correction.

A gesture operation is determined on the basis of a continuous change in a touch position. However, depending on the type of the coordinate input unit 102, a chattering phenomenon may occur, which is electrically determined as instantaneous release of a touch state even when a touch is made physically, or a phenomenon in which touch coordinates change even when touch is made at one point may occur. Accordingly, in an actual process, it is preferable that the operation processing unit 108 has a function of performing a signal smoothing process, in which calculation of a moving average is performed with use of not only a current touch position but also touch positions collected for several times in the past.

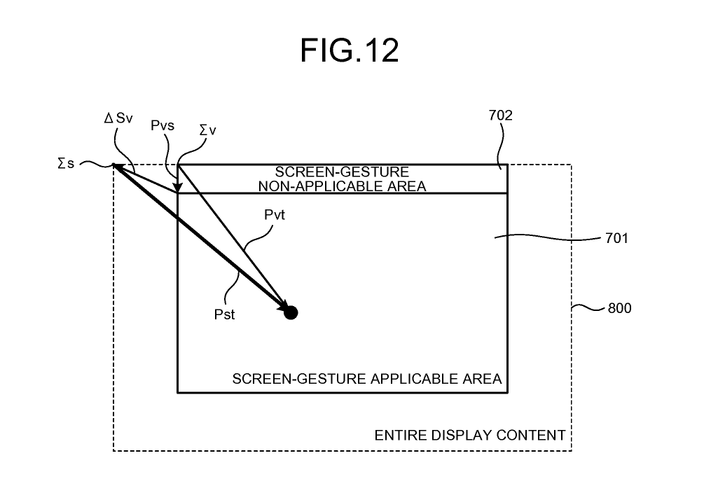

Next, a process in the normal operation mode after scroll or zoom is applied is described. The result of zoom and/or scroll performed in the screen gesture mode continues even when the mode shifts to the normal operation mode afterwards. FIG. 12 is a diagram illustrating a relation between coordinate positions before and after zoom and/or scroll is applied. In this case, when a coordinate system of an image that is not zoomed or scrolled is a reference coordinate system Σv, a coordinate system of the display content 800 displayed in the screen-gesture applicable area 701 is a display-content coordinate system Σs, a vector pointing at the upper-left coordinates of the screen-gesture applicable area 701 in the reference coordinate system Σv is Pvs, a zoom amount is Z, and a scroll amount that is a displacement of a reference point of the display content 800 with respect to the screen-gesture applicable area 701 is ΔSv, coordinates Pst in the display-content coordinate system Σs with respect to touch coordinates Pvt in the reference coordinate system Σv are calculated by the following expression (2).

Pst=(Pvt−Pvs+ΔSv)/Z (2)

That is, when zoom or scroll is applied to the display content 800 in the screen-gesture applicable area 701, the touch point Pvt on the display unit 101 is regarded as touch on the coordinates Pst in the display content 800. Coordinates of objects in the project data 180 are managed without zoom or scroll. Therefore, touched coordinates are corrected by using the above expression to determine the presence of an operation object. When the coordinates Pst point an area in an operation object, operations of the operation object are performed.

The programmable display device 100 can also have a system for obtaining touch coordinates as input information for a simple programming language that is referred to as “script” or “macro”. When a script and touch coordinates are combined, for example, a graphic image can be displayed at a touched position or values corresponding to touched coordinates can be set. Even when the touch coordinates are used for the above applications, in the normal operation mode, in addition to operations of the operation object, as a touch operation obtains touch coordinates in the display screen and uses the coordinates Pst corrected by the expression (2) as touch coordinates, a process using appropriate touch coordinates can be also performed on images to which zoom or scroll is applied.

In the above descriptions, the programmable display device 100 including a touch panel capable of inputting coordinates of a plurality of points has been exemplified. However, there is no limitation on the programmable display device 100, and any device can be used as the programmable display device 100 as long as the device includes the display unit 101 and the coordinate input unit 102 capable of detecting operation coordinates of one or more arbitrary points. In the above descriptions, operations are regarded as touch operations; however, for example, expansion to a system for detecting operation coordinates with a non-contact sensor such as a camera can be included in the operations described above. Further, the programmable display device 100 can be a device of an installation type that is installed in an operation panel thereof, a device of a portable type that is carried by hand and used, or a device such as a head mounted display that is mounted on the user's head.

In the above descriptions, touch operations at one or two points have been explained; however, it is also possible to provide a function of performing simultaneous touch operations at three or more points.

Furthermore, in the above descriptions, while means for switching between the screen gesture mode and the normal operation mode and operations in the screen gesture mode have been explained, the combination of the means and the operations is arbitrary, and it is not necessary to realize all the operations at the same time.

In the present embodiment, operations on operation objects arranged in the screen-gesture applicable area 701 are invalidated in the screen gesture mode. With this configuration, as operations to change the display content 800 in the screen-gesture applicable area 701, when processes such as enlargement, reduction, change of the display position (scrolling) of the display content 800 are performed by operations accompanied with touch, such as pinch-out, pinch-in, and dragging (flicking), it is possible to prevent operation objects included in the display content 800 from being erroneously operated.

Furthermore, change of the display content 800 is performed only within the screen-gesture applicable area 701. Therefore, by limiting the size of the screen-gesture applicable area 701 within a part of the display unit 101, the screen-gesture non-applicable area 702 is not influenced by the change of the display content 800. Accordingly, as an arbitrary object is arranged in the screen-gesture non-applicable area 702, the object can be always displayed or operated without being influenced by screen gestures. That is, even when the screen-gesture applicable area 701 is covered with a switch by a screen gesture, switching to the screen gesture mode can be performed by another switch arranged in the screen-gesture non-applicable area 702 or by a predetermined operation.

Furthermore, in the screen gesture mode, predetermined display indicating that the display screen is in the screen gesture mode is made in the display screen; therefore, it is possible to visually distinguish whether the display screen is in the screen gesture mode or the normal operation mode. If the modes are not visually distinguished in such a way, a user cannot be aware of an operation corresponding to the mode when operating a computer device, and cannot estimate the response to the operation in advance. This results in causing stress for the user or causing incorrect operations. However, in the present embodiment, the modes are visually distinguished from each other, and thus the user can be aware of an operation corresponding to the mode and can estimate the response to the operation in advance. As a result, the causes of stress for the user or causes of incorrect operations can be eliminated.

Further, the display function of indicating that the display screen is in the screen gesture mode is such that the screen is displayed only in the screen gesture mode and is not displayed in the normal operation mode; therefore, it is possible to design screens for which no additional display is required in the normal operation mode.

When the screen gesture mode and the normal operation mode are switched by performing a predetermined operation with respect to an area other than areas in which objects are arranged, it is not necessary to provide an operation object such as a switch for switching the mode in the screen. Further, even when the screen-gesture applicable area 701 is filled with touch switches as a result of enlarged display in the screen-gesture applicable area 701, mode switching can be performed by combining with the screen-gesture non-applicable area 702.

### INDUSTRIAL APPLICABILITY

As described above, the programmable display device according to the present invention is useful as a touch-panel programmable display device including a display screen in which operation objects are arranged.

### REFERENCE SIGNS LIST

100 programmable display device, 101 display unit, 102 coordinate input unit, 103 communication interface unit, 104 external-storage interface unit, 105 internal storage unit, 106 file-system processing unit, 107 display processing unit, 108 operation processing unit, 109 communication processing unit, 110 control unit, 120 external connection device, 130 personal computer, 131 drawing software, 150 external storage medium, 180 project data, 610 base screen, 620 window screen, 700 display area, 701 screen-gesture applicable area, 702 screen-gesture non-applicable area, 703 thick line, 710 mode switching switch, 720 operation object, 850 input indicator.

1. A programmable display device that monitors and operates a control device connected to the programmable display device via a communication line, the programmable display device comprising:
a display unit;
a coordinate input unit that detects at least one operation coordinate of an input indicator that is in contact with the display unit;
a display processing unit that displays, in a display screen displayed in the display unit, a plurality of objects including a display object displaying only information or an operation object that is operable;
an operation processing unit that extracts change of the input indicator from the operation coordinate of the input indicator obtained by the coordinate input unit;
a control unit that performs a specified operation according to change of the input indicator; and
a switching unit that switches between validation and invalidation of an operation by a screen gesture, wherein
the display screen includes a screen-gesture applicable area in which display content is capable of being changed by an operation by the screen gesture and a screen-gesture non-applicable area in which display content is not capable of being changed by an operation by the screen gesture,
the operation object arranged in the screen-gesture non-applicable area is operable regardless of whether an operation by the screen gesture is valid or invalid,
the operation object is operable in ON synchronization in which an operation on the operation object is performed at a time of touch by the input indicator,
the screen-gesture non-applicable area is always set in a specified area in the display screen,
when an operation by the screen gesture is invalid, the switching unit validates an operation on the operation object in the screen-gesture non-applicable area, and, when an operation by the screen gesture is valid, the switching unit invalidates an operation on the operation object in the screen-gesture applicable area and validates the screen gesture,
when an operation by the screen gesture is valid, the display processing unit performs specified display in the screen-gesture applicable area, and
in a case where an operation by the screen gesture is invalid, the control unit performs an operation on the operation object in ON synchronization when the operation processing unit detects that the input indicator has touched the operation object.

2. The programmable display device according to claim 1, wherein change of display content in the screen-gesture applicable area includes enlargement and reduction of the display content and change of a display position in the screen-gesture applicable area.

3. The programmable display device according to claim 2, wherein
the coordinate input unit detects the operation coordinate of two points of the input indicator that is in contact with the display unit,
the operation processing unit uses a distance between two points at a start of an operation as a reference distance, and calculates distance change between a distance between present two points and the reference distance when the operation of the two points continues after the start of the operation, and
the control unit enlarges or reduces display content in the screen-gesture applicable area on a basis of the distance change.

4. The programmable display device according to claim 2, wherein
the coordinate input unit detects the operation coordinate of one point of the input indicator that is in contact with the display unit,
the operation processing unit uses a coordinate of one point at a start of an operation as a reference coordinate, and calculates a displacement between a present operation coordinate and the reference coordinate when the operation of the one point continues after the start of the operation, and
the control unit changes a display position of display content in the screen-gesture applicable area on a basis of the displacement.

5. The programmable display device according to claim 1, wherein the switching unit is associated with an operation of continuously touching, by the input indicator, an area other than the operation object for a specified time period.

6. The programmable display device according to claim 1, wherein the switching unit is associated with two touch operations performed by the input indicator on an area other than the operation object within a specified time period.

7. The programmable display device according to claim 1, wherein the switching unit is an operation object provided in the screen-gesture non-applicable area.

8. The programmable display device according to claim 5, wherein when a no-operation state continues for a specified time period in a state where an operation by the screen gesture is valid, the switching unit switches from a state where an operation by the screen gesture is valid to a state where an operation by the screen gesture is invalid.

9. The programmable display device according to claim 1, wherein the screen-gesture non-applicable area is an area other than the screen-gesture applicable area in the display screen and is displayed while being switched to arbitrary display content only when an operation by the screen gesture is valid.

10. A screen-operation processing program for a programmable display device that monitors and operates a control device connected to the programmable display device via a communication line and performs processing on a basis of an instruction input to a display unit via an input indicator, the program causing the programmable display device to execute:
a step of causing the display unit to display a display screen including a screen-gesture applicable area in which display content is capable of being changed by an operation by the screen gesture and a screen-gesture non-applicable area in which display content is not capable of being changed by an operation by the screen gesture, displaying, in the display screen, a plurality of objects including a display object displaying only information or an operation object that is operable, causing the operation object arranged in the screen-gesture non-applicable area to be operable regardless of whether an operation by the screen gesture is valid or invalid, causing the operation object to be operable in ON synchronization in which an operation on the operation object is performed at a time of touch by the input indicator, and setting the screen-gesture non-applicable area always in a specified area in the display screen;
a step of detecting at least one operation coordinate of the input indicator that is in contact with the display unit;
a step of extracting change of the input indicator from the operation coordinate of the input indicator;
a step of performing a specified operation according to change of the input indicator;
a step of switching between validation and invalidation of an operation by a screen gesture according to an instruction from the input indicator;
a step of, when an operation by the screen gesture is invalid, validating an operation on the operation object in the screen-gesture non-applicable area;
a step of, when an operation by the screen gesture is valid, invalidating an operation on the operation object in the screen-gesture applicable area, validating the screen gesture, and performing specified display in the screen-gesture applicable area; and
a step of, in a case where an operation by the screen gesture is invalid, performing an operation on the operation object in ON synchronization when it is detected that the input indicator has touched the operation object.

11. The programmable display device according to claim 6, wherein when a no-operation state continues for a specified time period in a state where an operation by the screen gesture is valid, the switching unit switches from a state where an operation by the screen gesture is valid to a state where an operation by the screen gesture is invalid.

12. The programmable display device according to claim 7, wherein when a no-operation state continues for a specified time period in a state where an operation by the screen gesture is valid, the switching unit switches from a state where an operation by the screen gesture is valid to a state where an operation by the screen gesture is invalid.
